(19) United States
(12) Patent Application Publication
(10) Pub. No.: US 2026/0357035 A1
(43) Pub. Date: Nov. 12, 2026

(54) POLYMER COMPOSITION SUITABLE FOR ELECTROSTATIC DISCHARGE APPLICATIONS

(71) Applicant: SOLVAY SPECIALTY POLYMERS USA, LLC, Alpharetta, GA (US)

(72) Inventors: Sheng Ying Qian, Shanghai (CN); Xiaoling Lynn Xu, Cumming, GA (US)

(73) Assignee: SOLVAY SPECIALTY POLYMERS USA, LLC, Alpharetta, GA (US)

(21) Appl. No.: 19/122,213

(22) PCT Filed: Oct. 17, 2022
(86) PCT No.: PCT/CN2022/125566

§ 371 Date: Apr. 17, 2025

(51) Int. Cl. C08K 3/04; C08J 3/20; C08K 3/34; C08K 7/00; C08K 9/04; H01B 1/24; H05F 3/00

(52) U.S. Cl. CPC C08K 3/041; C08J 3/201; C08K 3/34; C08K 7/00; C08K 9/04; H01B 1/24; H05F 3/00; C08J 2371/10; C08K 2003/343; C08K 2201/001; C08K 2201/011

(57) ABSTRACT

Provided is a polyarylether composition (C) including at least one poly(aryl ether ketone) polymer (“PAEK polymer”), at least one electrically conductive carbon nanofiller (“component A1”), and at least one non-fibrous filler (“component A2”). Also provided is an article, particularly for electrostatic dissipative applications such as a substrate carrier, including the polyarylether composition (C).

### TECHNICAL FIELD

The present invention relates to a reinforced polyarylether composition, notably suitable for electrostatic discharge applications, and to an article comprising it or made therefrom.

### BACKGROUND

It is known that conductive thermoplastic polymer compositions can be applied for protection from electrostatic discharge (ESD). These specialty polymer compositions are generally tailored to span the surface resistivity spectrum, and can often be formulated for injection molding or extrusion processes.

Multiple technologies are available to impart conductive properties into thermoplastic resins that are otherwise insulative in nature, providing the exact degree of conductivity required for ESD protection. Among others, a conductive filler can be added to the thermoplastic polymer.

Small size carbon material, such as nanotube, is one of the most important filler materials. It can advantageously increase the strength of the polymeric materials and make the polymeric materials conductive. However, the fibrous shape combined with their small size makes them difficult to uniformly disperse in polymers.

US 2010/0311869 A1 teaches it is possible to obtain better dispersion when using hollow carbon nanospheres, which is not commercially available. To achieve the desired shape, it is necessary to use a complicated process for preparing the carbon nanospheres.

U.S. Pat. No. 8,128,844 B2 discloses the use of an organo nanoclay in the electrically conductive thermoplastic resin composition to minimize or prevent the tendency of the carbon nanotubes to aggregate or unexpectedly orient and can enable the carbon nanotubes to be uniformly dispersed in the resin. Said organo nanoclay is typically prepared by organically-modifying a nano-scale layered silicate.

Among other thermoplastic polymers, poly(aryl ether ketone) (PAEK) s, in particular polyetheretherketones (PEEK) and polyetherketoneketones (PEKK), offer an excellent thermal stability, very high stiffness and strength, and really excellent chemical resistance, including excellent resistance to environmental stress rupture resistance. However, they have drawbacks, such as poor toughness and impact resistance (with brittle failures) and have a rather low heat deflection temperature, which does not make them suitable, in general, for ESD applications. Hence, a lot of effort has been made for improving the performance of the conductive PAEK polymer. For instance, WO 2008/003659 A1 discloses a polymer composition (C) comprising at least one poly(aryl ether ketone) (PAEK), at least one poly(biphenyl ether sulfone) and at least one fibrous carbon nanofiller, which offering excellent protection from electrostatic discharge in particularly by providing excellent protection from electrostatic discharge, with substantially the same level of toughness as that of neat poly(biphenyl ether sulfone (i.e. no break at unnotched Izod ASTM D4812 test), and with a chemical resistance much higher than that of poly(biphenyl ether sulfone) s. However, there is no teaching on how to uniformly disperse the electrical conductive fillers.

### SUMMARY

Hence a first object of the present invention relates to a polyarylether composition (C) comprising:
at least one poly(aryl ether ketone) polymer (hereinafter “PAEK polymer”),
at least one electrically conductive carbon nanofiller (hereinafter “component A1”), and
at least one non-fibrous filler (hereinafter “component A2”).

Another object of the present invention relates to an article comprising, or made from, said polyarylether composition (C), said article having a volume resistivity, measured according to ASTM D257, of from 1·10⁺⁵ Ω·cm up to 5·10⁺¹² Ω·cm.

The Applicant has found that the polyarylether composition (C) of the present invention, as detailed herein, thanks to the blending of the PAEK polymer with component A1 and component A2, is effective in improving the uniformity of the electrical conductivity and therefore optimizes the volume and surface resistivity, making the polymer material more suitable for ESD applications. Furthermore, the polyarylether composition (C) of the present invention also optimizes the mold shrinkage of filled ESD polymer material, without sacrificing its mechanical performance.

### DETAILED DESCRIPTION OF PREFERRED EMBODIMENTS

The polyarylether composition (C) according to the present invention, may comprise:
at least 40 wt. % to less than 89 wt. % of at least one PAEK polymer,
at least 1 wt. % and at most 10 wt. % of the component A1, and
at least 10 wt. % and at most 50 wt. % of the component A2,
   said wt. % being based on the total weight of the polyarylether composition (C).

The polyarylether composition (C) according to the present invention, may comprise:
at least 40 wt. % and at most 78 wt. % of at least one PAEK polymer,
at least 2 wt. % and at most 10 wt. % of the component A1, and
at least 20 wt. % and at most 50 wt. % of the component A2,
   said wt. % being based on the total weight of the polyarylether composition (C).

The polyarylether composition (C) according to the present invention, may comprise:
at least 55 wt. % and at most 79 wt. % of at least one PAEK polymer,
at least 1 wt. % and at most 5 wt. % of the component A1, and
at least 20 wt. % and at most 40 wt. % of the component A2,
   said wt. % being based on the total weight of the polyarylether composition (C).

The polyarylether composition (C) according to the present invention, may further comprise at least one other polymer different than the PAEK polymer. The other polymer may include a polymeric carrier into which the component A1 is dispersed prior to being mixed with the other components of the polyarylether composition (C). The other polymer may, alternatively or additionally, comprise at least one poly(biphenyl ether sulfone) (hereinafter “component A3”) and/or at least one polyethersulfone (hereinafter “component A4”). In such instance, the combined weights of the at least one PAEK polymer, the component A1, the optional other polymer(s) (e.g., polymeric carrier, component A3, component A4), and the component A2 are equal to or less than 100 wt. % of the polyarylether composition (C).

The polyarylether composition (C) according to the present invention, may further comprise optional additive(s), generally not exceeding 10 wt. % based on the total weight of the polyarylether composition (C). The combined weights of the at least one PAEK polymer, the component A1, the optional other polymer, the component A2 and optional additive(s) are equal to or less than 100 wt. % of the polyarylether composition (C).

### The Poly(Aryl Ether Ketone) (PAEK) Polymer

As previously mentioned, the polyarylether composition (C) comprises at least one PAEK polymer.

For the purpose of the present invention, the term “poly(aryl ether ketone)” or “PAEK” is intended to denote any polymer of which more than 50 wt. % at least 60 wt. %, at least 70 wt. %, at least 80 wt. %, at least 90 wt. %, at least 95 wt. %, at least 99 wt. % of the recurring units are recurring units (R1) of one or more of the following formulae (I) to ((V):

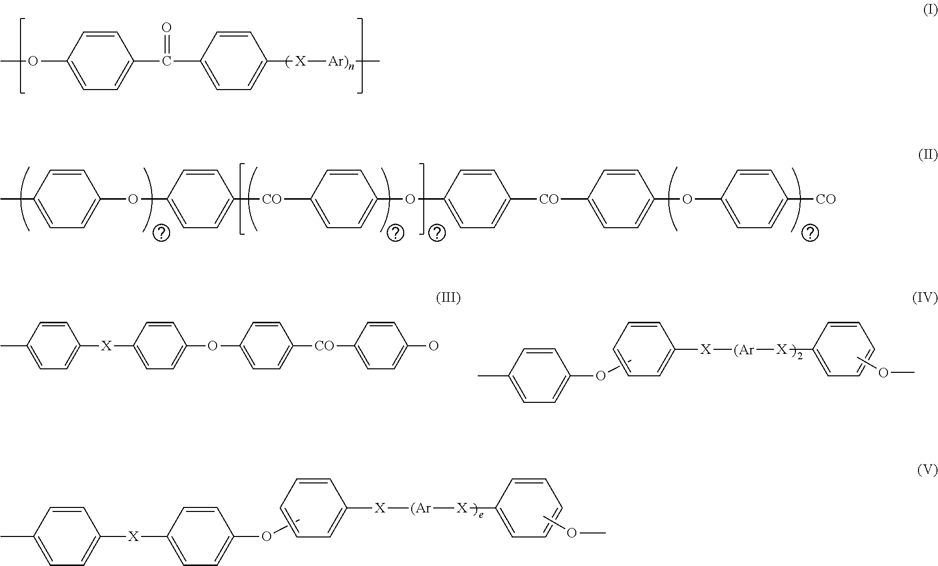

wherein:
Ar is independently a divalent aromatic radical selected from phenylene, biphenylene or naphthylene,
X is independently O, C(═O) or a direct bond,
n is an integer from 0 to 3,
b, c, d and e are 0 or 1,
a is an integer from 1 to 4, and
preferably, dis 0 when b is 1.

Recurring units (R1) may notably be chosen from:

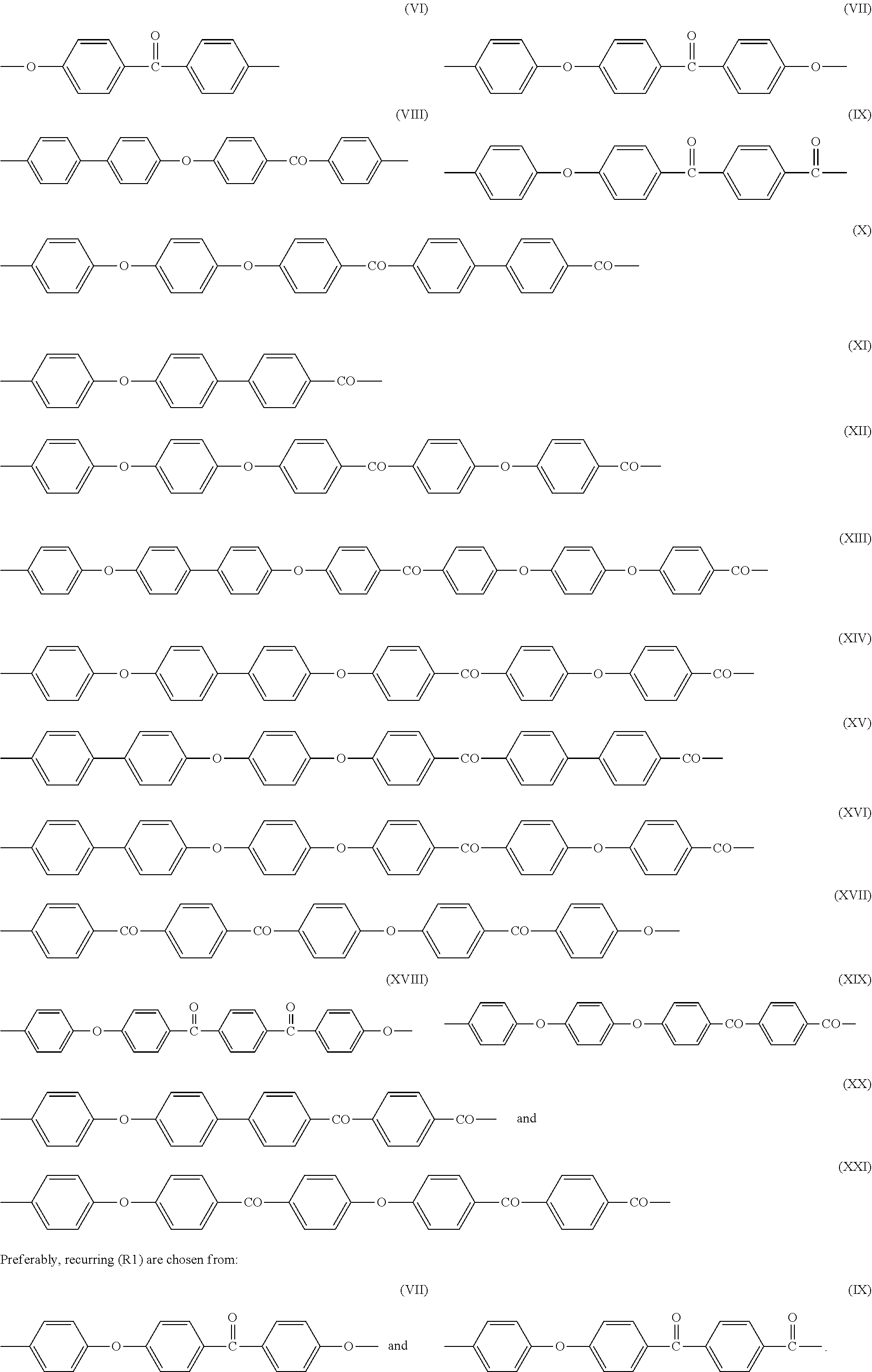

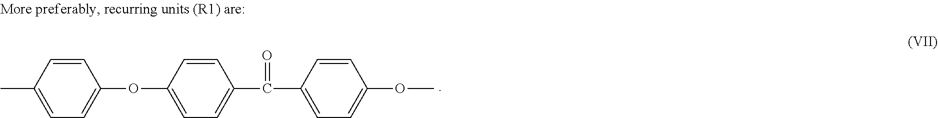

For the purpose of the present invention, a polyetheretherketone (PEEK) polymer is intended to denote any polymer of which more than 50 wt. % of the recurring units are recurring units (R1) of formula (VII). Preferably, at least 60 wt. %, at least 70 wt. %, at least 80 wt. %, at least 90 wt. %, at least 95 wt. %, at least 99 wt. % of the recurring units of the PEEK polymer are recurring units (R1) of formula (VII). Still more preferably, essentially all the recurring units of the PEEK polymer are recurring units (R1) of formula (VII). The most preferably, all the recurring units of the PEEK polymer are recurring units (R1) of formula (VII).

Preferably, the PAEK polymer, such as the PEEK polymer, used in the present invention is not sulfonated.

Excellent results are obtained when the PAEK polymer is a polyetheretherketone (PEEK) homopolymer, i.e. a polymer of which essentially all, if not all, the recurring units are of formula (VII). Non limitative examples of suitable commercially available PEEK homopolymers are VICTREX® PEEKs from Victrex Manufacturing Ltd., KETASPIRE® PEEKs from Solvay Specialty Polymers and Zypeek® from Jilin Joinature Polymer Co., Ltd.

The PAEK polymer can have an intrinsic viscosity (IV) of at least 0.50 dl/g, preferably at least 0.60 dl/g, more preferably at least 0.70 dl/g, as measured in 95-98% sulfuric acid (d=1.84 g/ml) at a PAEK concentration of 0.1 g/100 ml.

The PAEK polymer, for example PEEK polymer, may have a melt viscosity as high as 0.25 kPa-s, but preferably lower than 0.20 kPa-s and most preferably less than 0.18 kPa-s at 400 °C and a shear rate of 1000 s⁻¹, as measured using a capillary rheometer in accordance with ASTM D3835. The PAEK polymer, for example PEEK polymer, may have a melt viscosity as low as 0.05 kPa-s.

The PAEK polymer, for example PEEK polymer, may have a melt viscosity at 400 °C and a shear rate of 1000 s⁻¹, as measured using a capillary rheometer in accordance with ASTM D3835, ranging from 0.05 kPa-s to 0.25 kPa-s, preferably from 0.06 kPa-s to 0.20 kPa-s, preferably from 0.07 kPa-s to 0.18 kPa-s, preferably from 0.08 kPa-s to 0.15 kPa-s.

As a capillary rheometer, a Kayeness Galaxy V Rheometer (Model 8052 DM) may be used.

The PAEK polymer, for example PEEK polymer, can be prepared by any method.

One well known in the art method contains reacting a substantially equimolar mixture of at least one bisphenol and at least one dihalobenzoid compound or at least one halophenol compound as described in Canadian Pat. No. 847,963. Non limitative example of bisphenols useful in such a process are hydroquinone, 4,4′-dihydroxybiphenyl and 4,4′-dihydroxybenzophenone; non limitative examples of dihalobenzoid compounds useful in such a process are 4,4′-difluorobenzophenone, 4,4′-dichlorobenzophenone and 4-chloro-4′-fluorobenzophenone; non limitative examples of halophenols compounds useful in such a process are 4-(4-chlorobenzoyl) phenol and (4-fluorobenzoyl) phenol. Accordingly, PEEK homopolymers may notably be produced by the nucleophilic process as described in, for example, U.S. Pat. No. 4,176,222, the whole content of which is herein incorporated by reference.

Another well-known in the art method to produce PEEK homopolymers comprises electrophilically polymerizing phenoxyphenoxybenzoic acid, using an alkane sulfonic acid as solvent and in the presence of a condensing agent, as the process described in U.S. Pat. No. 6,566,484, the whole content of which is herein incorporated by reference. Other poly(aryl ether ketone) s may be produced by the same method, starting from other monomers than phenoxyphenoxybenzoic acid, such as those described in U.S. Pat. Appl. 2003/0130476, the whole content of which is also herein incorporated by reference.

The polyarylether composition (C) can comprise one and only one PAEK polymer. Alternatively, it can comprise two, three, or even more than three PAEK polymers. Certain preferred mixtures of PAEK polymers are mixtures consisting of (i) at least one poly(aryl ether ketone) (PAEK)-a of which more than 50 wt. % of the recurring units, preferably essentially all the recurring units, and still more preferably all the recurring units are of formula

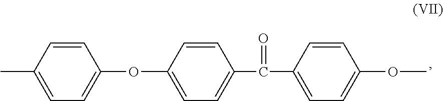

with (ii) at least one poly(aryl ether ketone) (PAEK)-b of which more than 50 wt. % of the recurring units, preferably essentially all the recurring units, and still more preferably all the recurring units are of formula

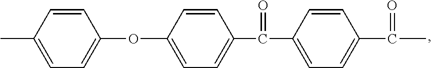

and, optionally in addition, with (iii) at least one other poly(aryl ether ketone) (PAEK)-c different from poly(aryl ether ketone) s (PAEK)-a and (PAEK)-b; in particular, mixtures consisting of (i) at least one poly(aryl ether ketone) (PAEK)-a of which essentially all, if not all, the recurring units are of formula (VII) with (ii) at least one poly(aryl ether ketone) (PAEK)-b of which essentially all, if not all, the recurring units are of formula (IX); still more particularly, binary mixtures consisting of (i) one poly(aryl ether ketone) (PAEK)-a of which all the recurring units are of formula (VII) with (ii) one poly(aryl ether ketone) (PAEK)-b of which all the recurring units are of formula (IX).

The amount of the PAEK polymer, based on the total weight of the polyarylether composition (C), is of at least 40 wt. %, preferably at least 41 wt. % or at least 42 wt. % or at least 43 wt. % or at least 44 wt. %, or at least 45 wt. %, or at least 47 wt. % or at least 49 wt. % or at least 55 wt. % or at least 55 wt. % and/or less than 89 wt. %, preferably at most 88 wt. %, or at most 87 wt. %, at most 86 wt. %, or at most 85 wt. %, or at most 80 wt. %, or at most 79 wt. %, or at most 78 wt. %, or at most 75 wt. %.

### The Electrically Conductive Carbon Nanofiller (Component A1)

The component A1 is at least one electrically conductive carbon nanofiller comprising elemental carbon. Generally, more than 90 wt. % of the nanofiller consist of elemental carbon. Preferably, more than 95 wt. % of the nanofiller consist of elemental carbon. Still more preferably, more than 99 wt. % of the nanofiller consist of elemental carbon. Good results are obtained when the nanofiller consist essentially of elemental carbon.

The at least one electrically conductive carbon nanofiller useful for the present invention may be metalized. However, the at least one electrically conductive carbon nanofiller is preferably not metalized.

From a practical point of view, any nanofiller is three-dimensional, and can thus be characterized notably by three characteristic dimensions (“length”, “width” and “height”). However, some nanofillers are such that two of their characteristic dimensions are considerably lower than respectively the third one. The terms “considerably lower” should generally be understood as “more than 10 times lower”, and preferably as “more than 100 times lower”. Precisely, for the purpose of the present invention, a carbon nanofiller has a shape of a fiber, meaning that two out of its characteristic dimensions (“width” and “height”) are, in average (in number), considerably smaller than the third dimension (“length”); insofar as the width is often close to the height of the fibrous nanofiller and that the base of the fibrous nanofiller often has a circular shape, the width and the height are commonly understood by the skilled person as a unique parameter, namely the diameter of the fibrous nanofiller. Hence the fibrous nanofiller will be generally characterized by a number average diameter and a number average length. Generally, such a material has an aspect ratio, defined as the ratio between the number average length and the number average diameter of at least 5, at least 10, at least 20, or at least 50, or at least 100.

The component A1 is at least one fibrous carbon nanofiller with its number average diameter generally less than 1000 nm, preferably less than 500 nm, and more preferably at most 200 nm.

The at least one fibrous carbon nanofiller may have a number average diameter of from 1 nanometer (nm) to 3.5 nm or 4 nm (when in a bundle or rope). The at least one fibrous carbon nanofiller may have a number average length of at least 1 μm. The at least one fibrous carbon nanofiller may have an average aspect ratio, defined as the number average length divided by the number average diameter, of 100 or more. The fibrous carbon nanofiller can have an average aspect ratio of 1000 or more.

The number average diameter and the number average length of the fibrous carbon nanofiller can be determined by any technique known from the skilled in the art; advantageously, direct measurement on micrographs obtained by Scanning Electron Microscopy (SEM) coupled with a software image analysis technique can be used.

The at least one fibrous carbon nanofiller contains above 65% of carbon. Preferably, the at least one fibrous carbon nanofiller contains at least 90% of carbon, and more preferably at least 95% of carbon.

The component A1 preferably has a volume resistivity of less than 2·10⁻² Ω·cm, or at most 1·10⁻² Ω·cm, or at most 5·10⁻³ Ω·cm, or at most 3·10⁻³ Ω·cm, or at most 2·10⁻³ Ω·cm, or at most 1·10⁻³ Ω·cm. The component A1 preferably has a volume resistivity of at least 1·10⁻⁶ Ω·cm, or at least 5·10⁻⁶ Ω·cm, or at least 1·10⁻⁵ Ω·cm. The component A1 may have a volume resistivity of from 1·10⁻⁴ Ω·cm up to 20·10⁻⁴ Ω·cm.

The at least one carbon nanofiller (component A1) is selected from the group consisting of carbon nanotubes, surface-modified carbon nanotubes, carbon nanostructures and any combination thereof.

A carbon nanotube (CNT) is intended to denote any material the structure of which comprises at least one graphene layer wound in the form of a hollow cylinder capped at least one of its ends, and preferably at each of them, by a half molecule of a fullerene. The term “cylinder” must be understood, with a broad geometric meaning, as a surface resulting from the rotation of a straight line parallel to a fixed rectilinear axis, thereby generating a curve around said axis. As examples of possible shapes of this curve, the circle and the ellipse can be notably cited.

When the structure of the carbon nanotube useful for the present invention comprises no more than one graphene monolayer, in such instance the carbon nanotube is generally referred to as “single wall carbon nanotubes” (SWCNT).

When the structure of the carbon nanotube useful for the present invention can comprises a coaxial assembly of two SWCNTs meaning one SWCNT nested in another, in such instance the carbon nanotube is generally referred to as “double-walled carbon nanotubes” (DWCNT).

When the structure of the carbon nanotube useful for the present invention comprises a coaxial assembly of several SWCNTs (nested SWCNTs), in such instance, the carbon nanotube is generally referred to as “multiwall carbon nanotube” (MWCNT). The MWCNT comprises generally above 3, preferably above 6, and more preferably above 10 coaxial SWCNTs and/or less than 60, preferably less than 40, and more preferably less than 20 coaxial SWCNTs.

Within the context of the present disclosure, the term “carbon nanotube” also includes carbon nano-rope which represents a bundle of carbon nanotubes (e.g., ropes of SWCNTs or MWCNTs).

Such carbon nanotubes are preferably selected from the group consisting of SWCNTs, DWCNTs, MWCNTs, ropes thereof, and any combination thereof, and more preferably selected from MWCNTs.

The number average diameter of the carbon nanotubes useful for the present invention may vary to a large extent, depending notably on whether SWCNT, DWCNT or MWCNT are used. Thus, the number average diameter of a SWCNT is usually above 0.3 nm, and preferably above 0.6 nm; besides, the diameter of a SWCNT is usually below 3.0 nm, and preferably below 2.0 nm. The number average diameter of a DWCNT is generally of at least 0.5 nm and preferably above 0.8 nm; it is generally of less than 6 nm, preferably of less than 5 nm, and more preferably of less than 4 nm. The number average diameter of a MWCNT is generally of at least 3 nm and preferably above 6 nm; it is generally of less than 60 nm, preferably of less than 40 nm, and more preferably of less than 20 nm. Certain suitable MWCNT have a number average diameter of from about 10 to about 15 nm.

The carbon nanotubes useful for the present invention have usually a length considerably much higher than their diameter (see for example Kirk-Othmer Encyclopedia of Chemical Technology (° John Wiley & Sons 2005), volume 17, Nanotechnology, pages 2 to 4). Concretely, the number average length diameter of the carbon nanotubes useful according to the present invention, measured along their longitudinal axis, can be several hundredths or even several thousands times higher than their number average diameter. This number average length is usually above 100 nm, preferably above 1 micron, and more preferably above 3 microns and/or generally below 100 microns, preferably below 50 microns, more preferably below 30 microns.

The number average diameter and the number average length of the carbon nanotubes can be determined by any technique known from the skilled in the art; advantageously, direct measurement on micrographs obtained by Scanning Electron Microscopy (SEM) coupled with a software image analysis technique can be used.

The carbon nanotubes useful for the present invention may be fabricated by any known technique. Non limitative examples of such methods include: arc discharge, pulsed laser vaporization (PLV), chemical vapor deposition (CVD) and gas-phase process. Arc discharge is a plasma-based process using a solid carbon electrode for MWCNT, or carbon composite for SWCNT. Pulsed-laser vaporization (PLV) method is used essentially for producing SWCNT, using a high power pulsed laser aimed at powdered graphite loaded with a metal catalyst. Chemical vapor deposition (CVD) can be used for making both SWCNT and MWCNT, by flowing heated precursor gas over a metallic catalyst. Also, a gas-phase process is available to produce both SWCNT and MWCNT.

The carbon nanotubes usually have a purity of above 65% of elemental carbon, the remaining consisting possibly of residual catalytic impurities. Preferably, the carbon nanotubes contain at least 90% of elemental carbon, and more preferably at least 95% of elemental carbon.

Preferably, the carbon nanotubes have a volume resistivity from 10⁻² to 10⁻⁶ Ω·cm, preferably from 10⁻³ to 10⁻⁵ Ω·cm.

SWCNT are commercially available notably from Sumitomo Shoji. DWCNT are commercially available from Nanograf. MWCNT are commercially available notably from Hyperion Catalysis, Mitsui Bussan, Nikkisou, Nanocyl, Applied Sciences, Shenzhen Nanotech, CNI, Sun Nanotech and Iljin Nanotech. Suitable MWCNTs include Nanocyl® NC7000 MWCNT grade having purity as low as 90% C purity or Nanocyl® NC3100 MWCNT grade with a C purity to greater than 95% C purity, both from Nanocyl (Belgium). Nanocyl® NC7000 MWCNTs have an average diameter of 9.5 nanometers, a mean length of 1.5 microns, a BET surface area of 250-300 m²/g and a volume resistivity of 1·10⁻⁴ Ω·cm. Other suitable sources for carbon nanotubes are FRIBIL® MWCNTs from Hyperion Catalysis International which have an outside diameter of about 10 nanometers and a length over 10 microns.

As mentioned previously, the component A1 useful for the present invention can be at least one surface-modified carbon nanotube, i.e., the external surface of the carbon nanotube can be chemically modified by functional groups, e.g. to increase their compatibility with the at least one PAEK polymer. Said functionalization of the carbon nanotubes can be of non-covalent or covalent nature, as explained notably in Kirk-Othmer Encyclopedia of Chemical Technology, supra, pages 8 et 9). The covalent functionalization is often preferred and can be achieved in a conventional manner by treating the carbon nanotubes with agents like oxidizing agents, acids and bases. The functional groups can be notably carboxyl groups, ester groups, ketone groups, sulfonate, sulfonyl groups or amino groups.

In a preferred embodiment, said surface-modified carbon nanotubes are amino grafted carbon nanotubes, as disclosed notably by Z. Cao et al./Applied Surface Science 353 (2015) pp. 873-881.

The number average diameter and the number average length of surface-modified carbon nanotubes useful for the present invention may vary to a large extent, depending notably on SWCNT, DWCNT or MWCNT before modification.

As mentioned previously, the component A1 useful for the present invention can be carbon nanostructures. Said carbon nanostructures are typically chemically cross-linked carbon nanotubes.

Cross-linked carbon nanotubes are notably commercial product Athlos™, available from Cabot Corporation.

The number average diameter and the number average length of nanostructures, notably chemically cross-linked carbon nanotubes useful for the present invention may vary to a large extent, depending notably on SWCNT, DWCNT or MWCNT before they are cross-linked.

Advantageously, the component A1 excludes carbon hollow nanospheres.

The component A1 may have a specific surface area (BET) from 100 to 800 m²/g, preferably from 150 to 600 m²/g, more preferably from 200 to 350 m²/g, and most preferably from 200 to 300 m²/g, measured according to Brunauer-Emmett-Teller method described in the periodical “The Journal of the American Chemical Society, 60, 309 (1938)”, such as ASTM D6556.

The amount of the component A1, based on the total weight of the polyarylether composition (C), is of at least 1 wt. %, preferably at least 1.5 wt. %, or more preferably at least 2 wt. %, and at most 10 wt. %, preferably at most 5 wt. %, more preferably at most 4 wt. %.

Because the component A1 may be difficult to handle due to its nanostructure, the component A1 may be first dispersed into a polymeric carrier to form a nanofiller masterbatch (“MB”). Then the PAEK polymer, the nanofiller MB, the at least one non-fibrous filler (component A2), and any optional components or additives are fed into a mixer, preferably a melt mixer. The polymeric carrier is preferably the same as the PAEK polymer in the polyarylether composition (C) but may be distinct from the PAEK polymer. In general the polymeric carrier is selected from polyaryletherketone polymers, such as those that comprise more than 50 wt. % of the recurring units (R1) of any of the formulae (I) to (XXI) described herein, but could also comprise or consist of a poly(biphenyl ether sulfone) or a polyethersulfone. The polymeric carrier is preferably the same as the PAEK polymer used in the polyarylether composition (C), and both the polymeric carrier and the PAEK polymer comprise more than 50 wt. % of the recurring units (R1) of the formula (VII).

### The Non-Fibrous Filler (Component A2)

The non-fibrous filler (component A2) is considered herein to have a tri-dimensional structure having a length, a width and thickness (or height).

The dimensions (length, width, thickness) of non-fibrous filler can be determined by direct measurement on micrographs obtained by Scanning Electron Microscopy (SEM).

The average dimensions (i.e., length, width and thickness) of the non-fibrous filler can be taken as the average length of the component A2 prior to incorporation into the polyarylether composition (C) or can be taken as the average dimensions of the component A2 in the polyarylether composition (C).

The non-fibrous filler (component A2) may be a particulate filler. A particulate filler has a low aspect ratio defined as the ratio of its largest dimension to its lowest dimension of less than 2. The particulate fillers are generally spherical or ovoid in shape. Examples of particulate fillers are zinc oxide, zinc sulfide, silica, dolomite, alumina, calcium sulfate, calcium carbonate, titanium oxide, clay, glass powder, nickel carbonate, iron oxide, quartz powder, magnesium carbonate, fluorocarbon resin, barium sulfate, graphite, and carbon powder.

The non-fibrous filler (component A2) may be in a flaky or platy form. A flaky or platy filler may have an aspect ratio defined as the ratio of its largest dimension to its lowest dimension of greater than 5, preferably at least 10. The flaky or platy filler has a substantially bidimensional shape, meaning wherein one dimension (thickness or height) is significantly less than the other two characteristic dimensions (width and length), like a thin plate. Examples of flaky or platy fillers are talc, kaolin, mica and glass flakes.

Glass flakes as a component A2 are silica-based glass compounds that contain several metal oxides which can be tailored to create different types of glass. The main oxide is silica in the form of silica sand; the other oxides such as calcium, sodium and aluminum are incorporated to reduce the melting temperature and impede crystallization. Any glass type, such as A, C, D, E, M, S, R, T glass or mixtures thereof, preferably C or E glass, may be used in the glass filler. C glass contains alkali components and has high acid resistance. E glass contains almost no alkali and so, it has high stability in resin and no electrical conductivity.

The glass flakes as component A2 preferably include, or consist of, glass flakes with C glass or E glass. Suitable glass flakes (C) with E or C glass are commercially available as GLASFLAKE® from NSG. E-glass flakes are particularly effective in preventing warpage and improving dimensional accuracy in precision parts made of thermoplastic polymers. FINEFLAKE® glass flakes also commercially available from NSG with an average thickness of 0.4 to 1 microns are suitable for fine and thin molded products. In some embodiments, the glass flakes may be granulated. For example, FLEKA® granulated glass flakes with E glass are commercially available from NSG.

Good results were obtained with mica in the form of a platy filler, such as Suzorite® from IMERYS. For example, the phlogopite mica product Suzorite® 200-HK is a platy mineral with a mean particle size of 60 microns.

The non-fibrous filler (component A2) useful for the present invention is preferably not electrically conductive.

Preferably, the non-fibrous filler (component A2) has a mean particle size distribution, also called d₅₀, ranging from 1 to 300 μm, preferably from 10 to 200 μm, preferably from 10 to 180 μm, as measured by electron microscopy or laser scattering in isopropanol.

The component A2 preferably may be selected from the group consisting of mica, metal-coated mica, glass flakes, wollastonite, talc, and any combination thereof.

The non-fibrous filler (component A2) is preferably not functionalized with at least one of: a sulfonate group, a phosphonic group, a carboxyl group (e.g., carboxylic acid groups), an amino, a hydroxyl group, or a thiol group.

The non-fibrous filler (component A2) does not include organically-modified mica such as a mica organically-modified with an organic phosphate or ammonium salt substituted with a C₁₂-C₃₆ alkyl group or a C₅-C₃₀ aromatic group.

When the flaky filler is present in the polyarylether composition (C), the average thickness of the flake can be from 0.1 to 5 μm, preferably from 0.2 to 2 μm, more preferably from 0.5 to 1.5 μm, as measured by electron microscopy.

The non-fibrous filler (component A2), based on the total weight of the polyarylether composition (C), is more than 10 wt. %, preferably at least 15 wt. %, more preferably at least 20 wt. %, yet more preferably at least 30 wt. %, and/or at most 50 wt. %, preferably at most 40 wt. %, more preferably at most 35 wt. %.

Furthermore, before blending, any pretreatment for combining the component A1 to the component A2 is not necessary. For instance, it is not necessary to coat the component A1 onto the component A2.

With the component A1 and component A2 present in the polyarylether composition (C), the weight of the PAEK polymer, based on the total weight of the polyarylether composition (C), is of at least 30 wt. %, or at least 40 wt. %, or at least 50 wt. % and/or of at most 90 wt. %, preferably at most 80 wt. %, more preferably at most 70 wt. %.

With the component A1 and component A2 present in the polyarylether composition (C), the PAEK polymer is preferably not cross-linked to the component A1 and/or the component A2. In particular, there is no linkage between the PAEK polymer and the component A2.

### Optional Other Polymer

The polyarylether composition (C) can further comprise at least one poly(biphenyl ether sulfone) (hereinafter “component A3”) and/or at least one polyethersulfone (hereinafter “component A4”).

For the purpose of the invention, a poly(biphenyl ether sulfone) is intended to denote a polycondensation polymer of which at least 50 mol. %, at least 60 mol. %, at least 70 mol. %, at least 80 mol. %, at least 90 mol. %, at least 95 mol. %, or at least 99 mol. % of the recurring units are recurring units (R2) chosen from:

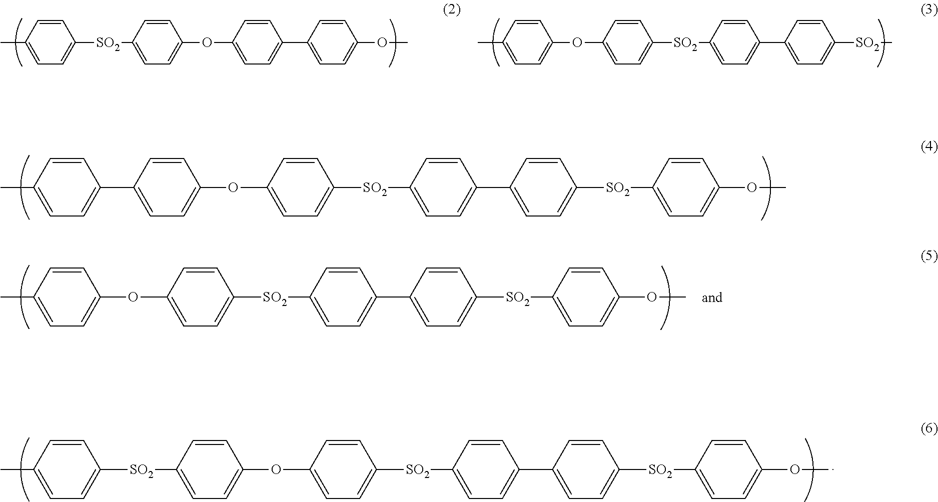

Using recurring units of formula (2) in recurring units (R2) provides in general the best overall cost-properties balance, and the highest level of toughness. For the purpose of the present invention, a polyphenylsulfone (PPSU) polymer is intended to denote any polycondensation polymer of which at least 50 mol % of the recurring units are recurring units (R2) of formula (2).

The poly(biphenyl ether sulfone) (component A3) may be notably a homopolymer, a random, alternating or block copolymer.

When the poly(biphenyl ether sulfone) (component A3) is a copolymer, its recurring units may notably be composed of (i) recurring units (R2) of at least two different formulae chosen from formulae (2) to (6), or (ii) recurring units (R2) of one or more formulae (2) to (6) (especially, recurring units of formula (2)) and recurring units (R2*), different from recurring units (R2), such as:

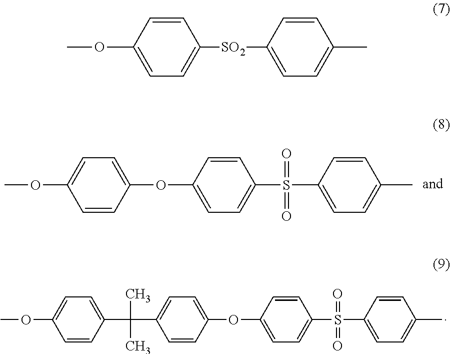

Preferably more than 70 mol %, more preferably more than 85 mol % of the recurring units of the poly(biphenyl ether sulfone) (component A3) are recurring units (R2) of formula (2). Still more preferably, essentially all the recurring units of the poly(biphenyl ether sulfone) (component A3) are recurring units (R2) of formula (2). Most preferably, all the recurring units of the poly(biphenyl ether sulfone) (component A3) are recurring units (R2) of formula (2).

Excellent results are in general obtained when the poly(biphenyl ether sulfone) (component A3) is a polyphenylsulfone homopolymer, i.e. a polymer of which essentially all, if not all, the recurring units are of formula (2). RADEL® polyphenylsulfone from Solvay Specialty Polymers USA, L.L.C. is an example of a polyphenylsulfone homopolymer (PPSU).

The poly(biphenyl ether sulfone) (component A3) can be prepared by any method. Methods well known in the art are those described in U.S. Pat. Nos. 3,634,355; 4,008,203; 4,108,837 and 4,175,175, the whole content of which is herein incorporated by reference.

The polyarylether composition (C) may comprise one and only one poly(biphenyl ether sulfone) (component A3). Alternatively, it can comprise two, three, or even more than three poly(biphenyl ether sulfone) s (component A3).

For the purpose of the invention, a polyethersulfone (component A4) denotes any polymer comprising at least 50 mol. %, at least 60 mol. %, at least 70 mol. %, at least 80 mol. %, at least 90 mol. %, at least 95 mol. %, or at least 99 mol. % of recurring units (RPES) of formula (J):

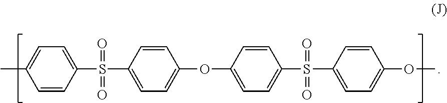

The mol. % is based on the total number of moles of recurring units in the polyethersulfone polymer.

The polyethersulfone polymer can be prepared by known methods, such as condensation of bisphenol S and dichlorodiphenol sulfone and is notably available as VERADEL® PESU from Solvay Specialty Polymers USA, L.L.C.

When a poly(biphenyl ether sulfone) (component A3) and/or a polyethersulfone (component A4) is present in the polyarylether composition (C), the weight of the PAEK polymer, based on the combined weights of PAEK polymer and component A3/component A4 in the polyarylether composition (C), is of at least 50 wt. %, preferably at least 60 wt. %, more preferably at least 70 wt. % and/or of at most 90 wt. %, preferably at most 80 wt. %.

The polyarylether composition (C) may further comprise a polymeric carrier which is distinct from the PAEK polymer present in the polyarylether composition (C). In general the polymeric carrier may be selected from polyaryletherketone polymers, such as those that comprise more than 50 wt. % of the recurring units (R1) of any of the formulae (I) to (XXI) described herein, but could also comprise or consist of a poly(biphenyl ether sulfone) or a polyethersulfone. The polymeric carrier preferably comprises more than 50 wt. % of the recurring units (R1) of the formula (VII). When such a polymeric carrier distinct from the PAEK polymer is present in the polyarylether composition (C), the weight of the PAEK polymer, based on the combined weights of PAEK polymer and the polymeric carrier in the polyarylether composition (C), is of at least 50 wt. %, preferably at least 60 wt. %, more preferably at least 70 wt. % and/or of at most 95 wt. %, preferably at most 90 wt. %.

### Optional Additive(s)

In some embodiments, the polyarylether composition (C) according to the invention includes an additive selected from the group consisting of ultra-violet (“UV”) stabilizers, heat stabilizers, pigments, dyes, flame retardants, impact modifiers, lubricants, nucleating agents, antioxidants, processing aids, and any combination of one or more thereof.

In some embodiments in which the polyarylether composition (C) includes optional additives, the total concentration of additives is no more than 15 wt. %, no more than 10 wt. %, no more than 5 wt. %, no more than 1 wt. %, no more 0.5 wt. %, no more than 0.4 wt. %, no more than 0.3 wt. %, no more than 0.2 wt. %, or no more than 0.1 wt. %.

One or more pigments can be particularly desirable additives in the polyarylether composition (C) to make a white, black or colored article. The pigment may be a black pigment such as carbon black, a white pigment such as zinc oxide, zinc sulfide, lithopone, antimony white and titanium dioxide (of rutile or anatase type, preferably rutile type), and/or a colored pigment. A pigment is generally present in an amount of from 0 to 6 wt %, preferably from 0.05 to 5 wt % and in particular from 0.1 to 3 wt %, based on the total weight of the polyarylether composition (C).

Antioxidants can be particularly desirable additives in the polyarylether composition (C). Antioxidants can improve the heat and light stability of the polyarylether composition (C). For example, antioxidants that are heat stabilizers can improve the thermal stability of the composition during manufacturing (or in high heat application settings), for example, by making the polymer processable at high temperatures while helping to prevent polymer degradation.

### Method for Making the Polyarylether Composition (C)

The polyarylether composition (C) according to the invention can be made using methods well known in the art.

For example, the polyarylether composition (C) is made by melt-blending the at least one PAEK polymer, the at least one electrically conductive carbon nanofiller (component A1), the at least one non-fibrous filler (component A2), and any optional components or additives. Any suitable melt-blending method may be used for combining the components of the polyarylether composition (C). For example, all of the components may be fed into a melt mixer, such as single screw extruder or twin screw extruder, agitator, single screw or twin screw kneader, or Banbury mixer. The components can be added to the melt mixer all at once or gradually in batches. When said components are gradually added in batches, a part of the components is first added and then is melt-mixed with the remaining part of the components, which are subsequently added, until an adequately mixed composition is obtained.

Because the carbon nanofiller (component A1) may be difficult to handle due to its nanostructure, the component A1 may be first dispersed into a polymeric carrier to form a nanofiller masterbatch (“MB”). Then the PAEK polymer, the nanofiller MB (containing component A1), the at least one non-fibrous filler (component A2), and any optional additives are fed into a melt mixer. The polymeric carrier in MB is preferably the same as the PAEK polymer in the polyarylether composition (C) but may be distinct from the PAEK polymer. In general the polymeric carrier is selected from polyaryletherketone polymers, such as those that comprise more than 50 wt. % of the recurring units (R1) of any of the formulae (I) to (XXI) described herein, but could also comprise or consist of a poly(biphenyl ether sulfone) or a polyethersulfone. The polymeric carrier is preferably the same as the PAEK polymer used in the polyarylether composition (C), and both the polymeric carrier and the PAEK polymer comprise more than 50 wt. % of the recurring units (R1) of the formula (VII).

### Article

As previously mentioned, the invention further pertains to an article, preferably a shaped article, comprising, or made from said polyarylether composition (C).

The polyarylether composition (C), as above detailed, can be processed by usual melt processing techniques, including notably extrusion molding, injection molding, and compression molding, so as to provide a shaped article.

Such an article has a volume resistivity, measured according to ASTM D257, of from 1·10⁺⁵ Ω·cm up to 5·10⁺¹² Ω·cm.

It has been found that the article has a surface resistivity of at least 10⁶ and at most 10⁹ Ω/sq.

Volume resistivity is the resistance to leakage current through the body of an insulating material. Surface resistivity is the resistance to leakage current along the surface of an insulating material.

It has also been found that the article has a flow mold shrinkage or a transversal mold shrinkage of at most 1.0%, at most 0.9%, at most 0.8%, or at most 0.7%, preferably from 0.1 to 0.6%, more preferably from 0.2 to 0.5%, based on method ASTM D955.

As used herein, the term “mold shrinkage” refers to the shrinkage of the polymer as it cools after the molding process. It is typically used to properly machine injection molds so that final part dimensions are as desired. A flow mold shrinkage refers to a mold shrinkage in the flow direction. A transversal mold shrinkage (or cross-flow mold shrinkage) refers to a mold shrinkage in the transverse (cross-flow) direction.

The shaped article of the invention is preferably selected from the group consisting of (i) an extruded shape, preferably selected from the group consisting of a rod, a slab, a tubing, a pipe or a profile; and (ii) an injection molded article.

According to certain embodiments shaped articles are under the form of substantially bidimensional articles, e.g. parts wherein one dimension (thickness or height) is significantly less than the other two characterizing dimensions (width and length), such as films, sheaths and sheets.

According to other embodiments, shaped articles are provided as three-dimensional parts, e.g. substantially extending in the three dimensions of space in similar manner, including under the form of parts with complex geometries, e.g. with concave or convex sections, possibly including undercuts, inserts, and the like.

The polyarylether composition (C) may be used to make electrostatic dissipative articles for example but not limited to substrate carriers. Substrate carriers may include but not limited to wafer carriers, reticle pods, shippers, chip trays, test sockets, head trays (read and/or write); fluid tubing, chemical containers, and the like.

Shaped articles may include but are not limited to portions or all of reticle carriers as illustrated in U.S. Pat. Nos. 6,513,654 and 6,216,873; disk shippers as illustrated in U.S. Pat. Nos. 4,557,382 and 5,253,755; chip trays as illustrated in U.S. Pat. No. 6,857,524; wafer carriers as illustrated in U.S. Pat. No. 6,848,578; wherein each of these references is incorporated herein by reference in its entirety into the present application.

According to certain embodiments, shaped articles made from the polyarylether composition (C), as above detailed, are provided as part(s) of an electrostatic discharge (ESD) protective device, which may, e.g., be designed for being connected to a semiconductor wafer intended for chip manufacture.

### EXAMPLES

The invention will now be described with reference to the following examples, whose purpose is merely illustrative and not intended to limit the scope of the invention. As used in the Examples, “E” denotes an example embodiment of the present invention and “CE” denotes a counter-example.

### Materials

PEEK: Ketaspire® KT-890P from Solvay Specialty Polymer
Component A1: MWCNTs: multi-walled carbon nanotubes Nanocyl® NC7000 from Mitsubishi Gas Chemical Co.; have an average diameter of 9.5 nanometers, a mean length of 1.5 microns, a BET surface area of 250-300 m²/g and a volume resistivity of 1·10⁻⁴ Ω·cm
   CNT masterbatch (CNT MB): 10 wt % of Nanocyl® NC7000 in 90 wt % Ketaspire® KT-890P PEEK
Component A2:
   Mica in platy form: Suzorite® 200-HK from IMERYS
   Glass flakes: very thin E-glass flakes MEG160FY-M03 from Nippon Sheet Glass Co. with an average length of 160 microns (flat surface) and a thickness of 0.7 microns

### Test Methods

Tensile properties—ISO 527

Tensile modulus, tensile strength, and elongation at break were measured on 5 injection molded ISO Type 1a tensile specimens (total length=170 mm, gauge length=50 mm, testing section width=10 mm, and thickness=4 mm).
Impact strength—ISO 180

Notched and un-notched Izod impact strength properties were measured in kJ/m² using 10 injection molded ISO type 1A bars (length of 80±2 mm, width of 10±0.2 mm, thickness of 4±0.2 mm).
Mold shrinkage—ISO 294 (ASTM D955)

Mold shrinkage (mold shrinkage in Flow Direction (%) and in Transverse Direction (%)) was measured on 5 injection molded plaques with dimensions 60 mm width by 60 mm length by 2 mm thick.
Volume and surface resistivity—ASTM D257

Volume and surface resistivities were measured on 5 injection molded plaques with dimensions 4″×4″×⅛″ (length×width×thickness) or 60 mm×60 mm×2 mm (length×width×thickness).

### Example 1

The resins and fillers were fed to a ZSK-26 mm co-rotating twin screw extruder using gravimetric feeders that were adjusted for each run to achieve the target blend ratio in Table 1. The compounding conditions for all the blends and controls are shown in Table 2. The set points on the extruder were the same for all the runs.

The composition prepared was then processed by injection molding according to ASTM D3641 to provide a shaped article.

TABLE 1

| Raw Materials | Composition for | Composition for | Composition for |
|---|---|---|---|
| (wt %) | E1 | E2 | CE3 |
| PEEK | 30 | 30 | 65 |
| CNT MB | 35 | 35 | 35 |
| CNT | 3.5 | 3.5 | 3.5 |
| PEEK | 31.5 | 31.5 | 31.5 |
| Mica | 35 | — | — |
| Glass flake | — | 35 | — |

TABLE 2

| Barrel Configuration | | |
|---|---|---|
| Target Melt Temp (°C) | | Value |
| Feed | Barrel 1, temp (°C) | 80 |
| Top Plug & Side Plug | Barrel 2, temp (°C) | 350 |
| Solid | Barrel 3, temp (°C) | 370 |
| Solid | Barrel 4, temp (°C) | 380 |
| Top Vent & Side Feed | Barrel 5, temp (°C) | 370 |
| Solid | Barrel 6, temp (°C) | 370 |
| Top Plug & Side Plug | Barrel 7, temp (°C) | 370 |
| Solid | Barrel 8, temp (°C) | 370 |
| Solid | Barrel 9, temp (°C) | 370 |
| Side Vacuum | Barrel 10, temp (°C) | 370 |
| Solid | Barrel 11, temp (°C) | 370 |
| Solid | Barrel 12, temp (°C) | 370 |

| | |
|---|---|
| Die Temp (°C) | 270 |
| Screw Speed (RPM) | 220~250 |
| Screw Torque (%) | 65~80 |
| Vacuum Level (mmHg) | 0.9 |
| Pelletizer Speed (m/min) | 20~22 |
| Throughput(Kg/hr) | 14 |

### Example 2

The three components to prepare sample E2 are listed in Table 1. The composition and the shaped article of Example 2 were prepared in the same way as Example 1.

### Comparative Example 3

Two components (PEEK, A1) to prepare sample CE3 are listed in Table 1.

The composition and the shaped article of Comparative Example 3 were prepared in the same way as Example 1.

As shown by the results in Table 3, the compositions (E1& E2) according to the invention were effective in improving the volume and surface resistivity of the articles and make the articles suitable for ESD applications. In comparison, the CE3 sample with only MWCNTs had poor volume and surface resistivity outside of ranges suitable for ESD applications.

Furthermore, the compositions (E1& E2) according to the invention optimized the mold shrinkage of the articles, reducing the mold shrinkage to 0.5% or 0.6%, in comparison with CE3 which had much higher flow and transverse mold shrinkages (1.5% and 1.6%, respectively).

TABLE 3

| Samples | | |
|---|---|---|
| E1 | E2 | CE3 |

| | | |
|---|---|---|
| Comment | CNT based multi-fillers | CNT only |

Mechanical Data

| | | | | |
|---|---|---|---|---|
| Tensile Strength | MPa | 105 | 148 | 78 |
| Tensile Elongation | % | 1.4 | 1.9 | 2.2 |
| Tensile Modulus | Gpa | 13.6 | 13.5 | 4.4 |
| Izod Strength (Notched) | kJ/m² | 3.3 | 5.3 | 5.5 |
| Izod Strength (Unnotched) | kJ/m² | 17 | 35 | 28 |

Basic physical properties

| | | | | |
|---|---|---|---|---|
| Density | g/cm³ | 1.63 | 1.59 | 1.32 |
| Mold Shrinkage (Flow) | % | 0.6 | 0.5 | 1.5 |
| Mold Shrinkage (x-Flow*) | % | 0.6 | 0.5 | 1.6 |

Electrical Properties

| | | | | |
|---|---|---|---|---|
| Volume Resistivity @25 V | Ω cm | 10⁷ | 10⁷ | 10⁸ |
| Surface Resistivity @ | Ω/sq | 10⁸ | 10⁸ | 10¹¹ |
| 100 V | | | | |

*x-Flow represents the transversal shrinkage.

The disclosure of all patent applications, and publications cited herein are hereby incorporated by reference, to the extent that they provide exemplary, procedural or other details supplementary to those set forth herein. Should the disclosure of any patents, patent applications, and publications which are incorporated herein by reference conflict with the description of the present application to the extent that it may render a term unclear, the present description shall take precedence. Any incorporation by reference of documents is limited such that no subject matter is incorporated that is contrary to the explicit disclosure herein.

While preferred embodiments of this invention have been shown and described, modifications thereof can be made by one skilled in the art without departing from the teaching of this invention. The embodiments described herein are exemplary only and are not limiting. Many variations and modifications of compositions, articles, and methods are possible and are within the scope of the invention. Accordingly, the scope of protection is not limited by the description set out above, but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention.

1. A polyarylether composition (C) comprising:
at least one poly(aryl ether ketone) polymer (PAEK polymer),
at least one electrically conductive carbon nanofiller (component A1), and
at least one non-fibrous filler (component A2),
wherein the polyarylether composition (C) comprises, based on the total weight of the polyarylether composition (C), at least 20 wt. % of the component A2.

2. The polyarylether composition (C) according to claim 1, wherein the PAEK polymer comprises, based on the total weight of recurring units in the PAEK polymer, more than 50 wt. % of recurring units (R_{PAEK}) represented by any formula selected from following formulae (I) to ((V): 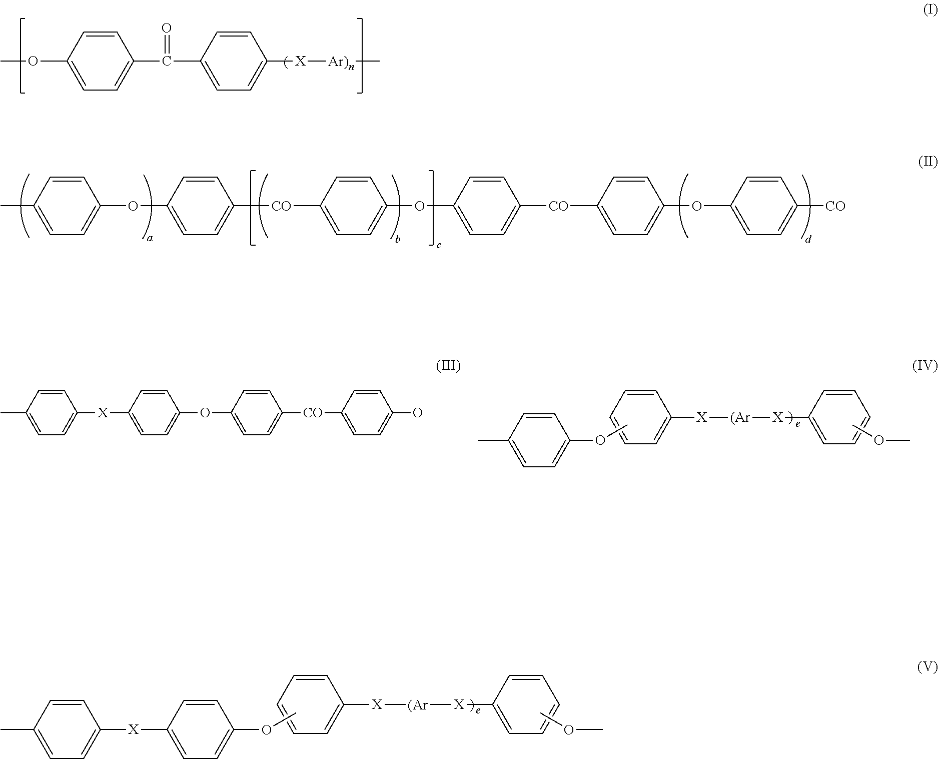
wherein:
Ar is independently a divalent aromatic radical selected from phenylene, biphenylene or naphthylene,
X is independently O, C(═O) or a direct bond,
n is an integer from 0 to 3,
b, c, d and e are 0 or 1, and
a is an integer from 1 to 4.

3. The polyarylether composition (C) according to claim 1, wherein the at least one electrically conductive carbon nanofiller (component A1) is selected from the group consisting of carbon nanotubes, surface-modified carbon nanotubes, carbon nanostructures and any combination thereof,
said carbon nanotubes or surface-modified carbon nanotubes being selected from the group consisting of single-walled carbon nanotubes, double-walled carbon nanotubes, multiwalled carbon nanotubes, ropes thereof, and any combination thereof, and
said carbon nanostructures being chemically cross-linked carbon nanotubes.

4. The polyarylether composition (C) according to claim 3, wherein the surface-modified carbon nanotubes are amino grafted carbon nanotubes.

5. The polyarylether composition (C) according to claim 1, wherein the component A1 excludes hollow carbon nanospheres.

6. The polyarylether composition (C) according to claim 1, wherein the polyarylether composition (C) comprises, based on the total weight of the polyarylether composition (C), at least 1 wt. %, and/or at most 10 wt. % of the component A1.

7. The polyarylether composition (C) according to claim 1, wherein said component A2 is selected from the group consisting of mica, metal-coated mica, glass flakes, wollastonite, talc, and any combination thereof.

8. The polyarylether composition (C) according to claim 1, wherein said component A2 is in platy or flaky form.

9. The polyarylether composition (C) according to claim 1, wherein the component A2 is not electrically conductive.

10. The polyarylether composition (C) according to claim 1, wherein the polyarylether composition (C) comprises, based on the total weight of the polyarylether composition (C), at least 30 wt. %, and at most 50 wt. % of the component A2.

11. (canceled)

12. The polyarylether composition (C) according to claim 1, comprising:
at least 40 wt. % to less than 89 wt. % of the at least one PAEK polymer,
at least 1 wt. % and at most 10 wt. % of the component A1, and
more than 10 wt. % and at most 50 wt. % of the component A2,
said wt. % being based on the total weight of the composition (C).

13. A method for making the polyarylether composition (C) according to claim 1, comprising melt-blending the PAEK polymer, the electrically conductive carbon nanofiller (component A1), the at least one non-fibrous filler (component A2), and any optional components or additives.

14. (canceled)

15. A shaped article suitable for electrostatic discharging applications comprising the polyarylether composition (C) of claim 1, said article having a volume resistivity, measured according to ASTM D257, of from 1·10⁺⁵ Ω·cm up to 5·10⁺¹² Ω·cm.

16. The shaped article of claim 15, having a surface resistivity of at least 10⁶ and at most 10⁹ Ω/sq and having a flow mold shrinkage or a transversal mold shrinkage of at most 1.0%, based on method ASTM D955.

17. The shaped article of claim 15, being a substrate carrier selected from the group consisting of wafer carriers, reticle pods, shippers, chip trays, test sockets, head trays, fluid tubing, and chemical containers.

18. The polyarylether composition (C) according to claim 1, wherein the polyarylether composition (C) comprises, based on the total weight of the polyarylether composition (C), at least 30 wt. % of the component A2.

19. The polyarylether composition (C) according to claim 1, wherein the PAEK polymer comprises, based on the total weight of recurring units in the PAEK polymer, more than 60 wt. % of recurring units (R_{PAEK}).

20. The polyarylether composition (C) according to claim 2, wherein d is 0 when b is 1.

21. The polyarylether composition (C) according to claim 1, wherein the polyarylether composition (C) comprises, based on the total weight of the polyarylether composition (C), at least 1.5 wt. % and/or at most 5 wt. % of the component A1.

22. The shaped article of claim 15, having a surface resistivity of at least 10⁶ and at most 10⁹ Ω/sq and having a flow mold shrinkage or a transversal mold shrinkage of from 0.1 to 0.6%, based on method ASTM D955.
